(19) United States
(12) Patent Application Publication
(10) Pub. No.: US 2005/0206943 A1
(43) Pub. Date: Sep. 22, 2005

(54) Print order receiving method and apparatus and printing system

(75) Inventor: Hiroshi Fukuda, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/085,069

(22) Filed: Mar. 22, 2005

(30) Foreign Application Priority Data
Mar. 22, 2004 (JP) 2004-083384

(51) Int. Cl. G06F 15/00

(52) U.S. Cl. 358/1.14; 358/1.18

(57) ABSTRACT

A server of a printing system estimates costs to be taken for printing images, in accordance with a reception status of order information which is for ordering printing of the image. On the basis of the estimated costs, the server calculates a usage fee every delivery time and date of print products. A print order receiving apparatus shows difference of the usage fees, which have been calculated by the server, on a display. The delivery time and date of the print products are selected by using an operating portion of the print order receiving apparatus.

### BACKGROUND OF THE INVENTION

1. Field of the Invention

The present invention relates to print order receiving method and apparatus for receiving order information, which is for ordering printing of images. The present invention further relates to a printing system comprising the print order receiving apparatus, a printer for printing the image on the basis of the order information, and a server, which is connected to the print order receiving apparatus and the printer via a communication network and integrally manages entire operations thereof.

2. Description of the Related Art

Digital print service becomes popular. In the digital print service, a print image having high quality is produced on the basis of image data recorded in a received recording medium of an exposed photographic film, a memory card storing the image data, and so forth. A system for providing such service is set up in a street DPE shop or the like. This system comprises a print order receiving apparatus of a self-operating type and a printer. The print order receiving apparatus receives order information, which is for ordering printing of images. The printer prints the image on the basis of the order information. The system is integrally managed by a server connected to the print order receiving apparatus and the printer via a communication network.

Among the servers used for the above-described printing system, the server in which a rate of change of print costs is preset in accordance with a season and a printer-operating ratio is proposed (see Japanese Patent Laid-Open Publication No. 2003-242242). In this kind of the server, a usage fee based on the print cost is automatically determined in accordance with the order information received from a customer, and printing desired by the customer is ordered after indicating the usage fee for the customer.

However, when the server described in the above Publication No. 2003-242242 is used, the print cost is reflected only by a situation of the moment that the order information has been received. Thus, the print cost is likely to be different from an actual cost taken for printing performed on the basis of the order information. Consequently, there is possibility of causing a problem in that an operator of the printing system has disadvantage in case the print cost is lower than the actual cost, and the customer has disadvantage in the reverse case.

### SUMMARY OF THE INVENTION

In view of the foregoing, it is a primary object of the present invention to provide print order receiving method and apparatus in which printing is ordered so as to be more suitable to a desire of a customer and a proper fee is always charged.

It is a second object of the present invention to provide a printing system in which printing is ordered so as to be more suitable to a desire of a customer and a proper fee is always charged.

In order to achieve the above and other objects, the print order receiving method for receiving order information, which is for ordering printing of images, comprises a step of calculating a usage fee every delivery time and date of print products on the basis of a reception status of the order information. The print order receiving method further comprises steps of displaying difference of the usage fees relative to the delivery time and date, and enabling the displayed delivery time and date to be selected.

The print order receiving apparatus for receiving the order information comprises a display for showing the difference of the usage fees relative to delivery time and date of the print products. The usage fee is calculated on the basis of the reception status of the order information. The print order receiving apparatus further comprises an operating portion for selecting the delivery time and date.

The printing system according to the present invention comprises the print order receiving apparatus for receiving the order information, a printer for printing the image on the basis of the order information, and a server connected to the print order receiving apparatus and the printer via a communication network to integrally manage operations of the print order receiving apparatus and the printer. The server calculates the usage fee every delivery time and date of the print products on the basis of the reception status of the order information.

In a preferred embodiment, the difference of the usage fees is displayed by indicating the usage fees in relation to the delivery time and date. It is preferable that the difference of the usage fees is displayed as a bar graph in which the usage fee is indicated every delivery time and date. Meanwhile, the usage fee is calculated in consideration of a cost to be taken for a printing operation of the print products, which is determined in accordance with the delivery time and date.

According to the present invention, it is possible to order the printing so as to be more suitable to the desire of the customer. Further, it is possible to always charge a proper fee. Thus, the system may be wholesomely operated.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is an explanatory illustration showing a schematic structure of a printing system according to the present invention;

FIG. 2 is a block diagram showing an electrical structure of a print order receiving apparatus;

FIG. 3 is an illustration showing an example indicating difference of usage fees on a display of the print order receiving apparatus; and

FIG. 4 is a flowchart showing procedures of the printing system.

### DETAILED DESCRIPTION OF THE PREFERRED EMBODIMENT(S)

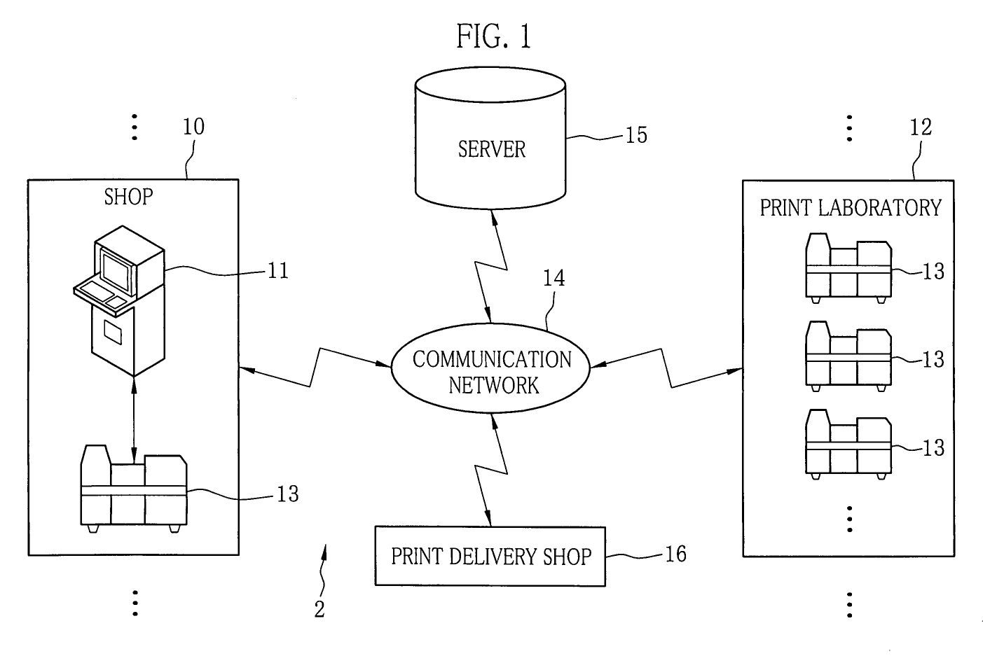

In FIG. 1, a printing system 2 according to the present invention comprises a print order receiving apparatus 11 of a self-operating type, a printer 13 for printing an image, and a server 15 connected to the print order receiving apparatus 11 and the printer 13 via a communication network 14 of the Internet and so forth. The print order receiving apparatus 11 is placed in a shop 10 of a street DPE shop, a convenience shop and so forth. The printer 13 is connected to the print order receiving apparatus 11. Alternatively, a plurality of the printers 13 are placed in a print laboratory 12 specializing in printing images. In this printing system 2, a recording medium is set to the print order receiving apparatus 11. The recording medium is an exposed photographic film, a memory card and so forth. The memory card stores data of images captured with a digital camera. The printer 13 prints the image on the basis of order information (personal information of a customer, a print number, a print size, delivery time and date, and a delivery place) inputted for ordering printing of the image. And then, print products are delivered at the shop 10 or a print delivery shop 16, and a usage fee is charged to the customer.

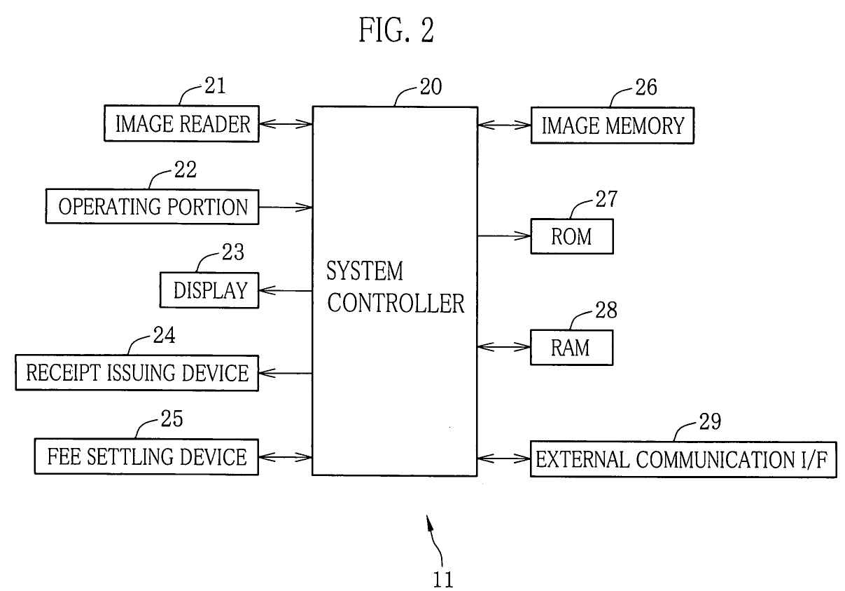

In FIG. 2, a system controller 20 controls the entire operation of the print order receiving apparatus 11. To the system controller 20, are connected an image reader 21, an operating portion 22, a display 23, a receipt issuing device 24, a fee settling device 25, an image memory 26, a ROM 27, a RAM 28 and an external communication I/F 29.

The image reader 21 is constituted of a film scanner, a card reader and so forth. The film scanner reads the image from the photographic film or the like, and the card reader imports the image from the memory card. The operating portion 22 comprises a keyboard and a mouse for inputting the order information. The display 23 shows the image, which is obtained by the image reader 21, and various menu pictures. Further, the display 23 shows difference of the usage fees relative to delivery time and date of the print products, such as described later.

The receipt issuing device 24 issues a receipt to the customer after the order has been completed. The receipt represents that the order of printing has been accepted. The order information inputted with the operating portion 22 is written on the receipt. In addition, a certification ID and so forth are also written on the receipt. The certification ID is used for checking the customer having ordered the printing. The fee settling device 25 is a so-called automatic cash dispenser to be loaded in a vending machine and so forth. The fee settling device 24 distinguishes kinds of inserted bills and coins, and pays change on the basis of a result of this distinction.

The image memory 26 saves the image data scanned by the image reader 21. The ROM 27 stores programs and various data, which are necessary for actuating the print order receiving apparatus 11. The RAM 28 stores the order information inputted through the operating portion 22.

The external communication I/F 29 mediates data communication for the printer 13 and the server 15. The print-ordered image data is transferred, together with the inputted order information, to the printer 13 of the shop 10 or to the server 15 via the external communication I/F 29.

In FIG. 1, the printer 13 comprises a well-known image printing device for projecting an image, which is displayed on an LCD, to a photosensitive material to be exposed. The printer 13 determines a turn of print jobs in accordance with delivery time and date of the order information sent from the print order receiving apparatus 11. The printer 13 is provided with a power-saving mode for reducing power consumption, and this mode is switched according to a degree of congestion of the print jobs.

The server 15 is managed by an operator of the print system 2. The server 15 monitors a status of reception of the order information, and also monitors operating conditions of the printer 13. In addition, the server 15 assigns the print jobs to the printers 13 placed in the print laboratory 12, and compiles a database of a fee structure, the image data, the order information and the certification ID.

In accordance with the reception status of the order information, the server 15 estimates costs to be taken for a printing operation of the print products. On the basis of the estimated costs, the serve 15 calculates the usage fee every delivery time and date of the print products. Concretely, the server 15 analyzes contents of the order information, which are currently accepted and of which the images have not yet been printed, to estimate the costs in consideration of the delivery time and date, the delivery place, a print number and a print size of the print products designated by the order information.

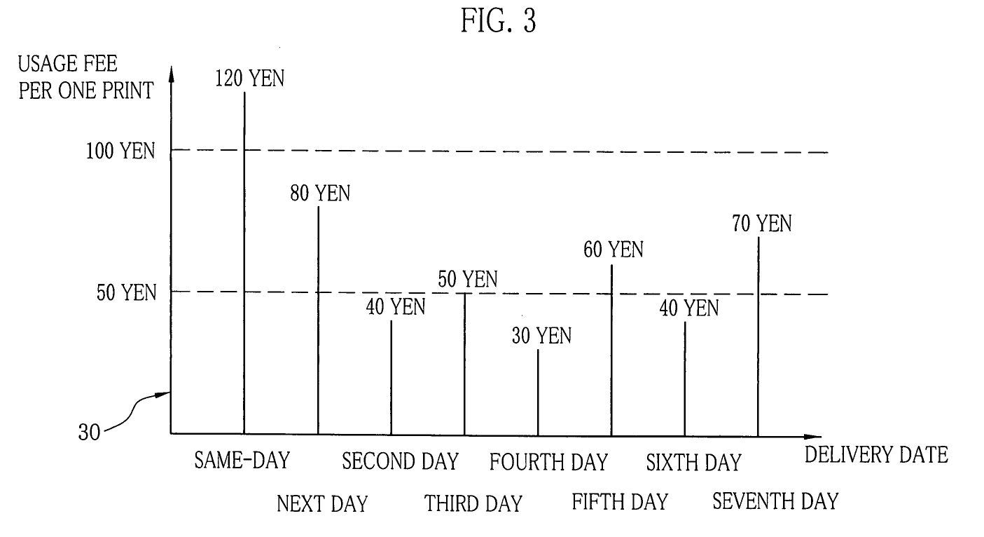

The server 15 sends the calculated usage fees to the print order receiving apparatus 11 by which the difference of the usage fees is shown on the display 23 as a graph 30 such as illustrated in FIG. 3. The customer selects the delivery time and date of the print products with the operating portion 22. Incidentally, instead of the graph 30, a table having the identical contents may be shown.

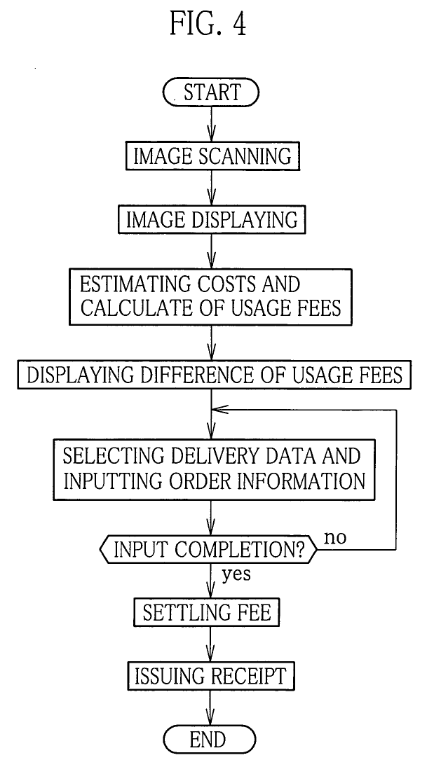

Next, procedures of the printing system 2 having the above structure are described below, referring to a flowchart shown in FIG. 4. First of all, the customer brings the exposed photographic film and the memory card to the shop 10. Then, the customer makes entry on the print order receiving apparatus 11 and sets the photographic film and the memory card to the image reader 21 of the print order receiving apparatus 11. The image reader 21 reads the image data from the set photographic film and the set memory card. The read image data is transferred to the image memory 26. The image data transferred to the image memory 26 is shown on the display 23.

After the customer has made the entry on the print order receiving apparatus 11, the server 15 estimates the costs to be taken for printing the image, in accordance with the reception status of the order information. On the basis of the estimated costs, the usage fees are calculated relative to the delivery time and date of the print products. The calculated usage fees are sent to the print order receiving apparatus 11.

The print order receiving apparatus 11 shows the graph 30 on the display 23 to indicate the difference of the usage fees calculated by the server 15. The customer operates the operating portion 22, viewing the graph 30 shown on the display 23, to select the convenient delivery time and date of the print products. The customer further selects the images to be printed, and then, the customer inputs the other order information. After completion of the input, the usage fee is collected by the fee settling device 25. Successively, the receipt is issued by the receipt issuing device 24.

The server 15 determines the turn of the print jobs to be assigned to the printer 13, in accordance with the delivery time and date of the order information inputted into the print order receiving apparatus 11. When the delivery time and date is designated on the following day or later and when an order number for printing is small, the printer 13 performs printing at preferable timing of nighttime and so forth during which an electric rate is low and a number of the print jobs is small. When the number of the print jobs is small, printing is performed under the power-saving mode. Sometimes, printing is collectively performed in the print laboratory 12 due to the designated date. In the print laboratory 12, the server 5 uniformly assigns the print jobs to the plural printers 13. Thus, the cost to be taken for printing may be reduced.

When the print delivery shop 16 is designated as the delivery place, printing is collectively performed in the print laboratory 12 and the print products are directly forwarded from the print laboratory 12 to the print delivery shop 16. In virtue of this, a distribution channel of the print products is simplified and the cost to be taken for delivery is reduced.

In a case of a single print size, it is unnecessary to exchange the paper set to the printer 13 so that it is possible to drive the printer 13 by an unattended operation. Consequently, labor costs to be taken for operators of the printer 13 are reduced.

After the print order has been received, the customer comes to the shop 10 or the print delivery shop 16 with the receipt, on the designated delivery time and date. And then, the customer receives the print products in exchange for the receipt.

In virtue of the above-described structure, it is possible to make the print order in accordance with various needs of the customers, for example, who desire to reduce the cost regardless of the time to be taken and who desire the same-day delivery regardless of the expensive usage fee. In this way, it is possible to include various selections in the order information. Further, it is possible to decentralize the print order.

Since the print orders decentralize, it is unnecessary to upgrade the printers 13, which are placed in the respective shops 10, so as to adapt to a most busy period of the print jobs. Thus, apparatus cost of the printer 13 and consumption of energy may be reduced. Further, since the print processing is concentrated in the print laboratory 12 and since the print jobs are uniformly assigned to the printers 13 placed in the print laboratory 12, it becomes possible to improve operative efficiency of the entire print processing.

Such as described above, the printing system 2 has advantage that the running cost of the system is reduced for the operator thereof. Further, the printing system 2 has the other advantage that the service is provided for the customer at a reasonable usage fee. Consequently, the customers of the print system 2 increase, and in accordance with this, the usage fee may be further lowered. It is possible to realize the management of the wholesome system.

Incidentally, when the server 15 estimates the cost to be taken for printing the image, the operating conditions of the printer 13 may be considered besides the reception status of the order information. Meanwhile, the usage fees may be respectively calculated in accordance with various terms of the print number, the print size, the delivery place and so forth. Further, the usage fees may be calculated in a state that the delivery time and date is segmented every hour.

In the forgoing embodiment, the print order receiving apparatus 11 is placed in the shop 10 of the DPE shop and the convenience shop. The print order receiving apparatus 11, however, is sufficient to be connected to the server 15 via the communication network. The present invention is applicable to a case in that the print order is received from a handheld terminal, for example which is a cell-phone having a camera, and from an information-processing equipment, for example which is a personal computer. In this case, the customer accesses Internet website of the system operator to make the print order on this website.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A print order receiving method for receiving order information, which is for ordering printing of images, said print order receiving method comprising the steps of:
calculating a usage fee every delivery time and date of print products on the basis of a reception status of said order information;
displaying difference of the usage fees relative to said delivery time and date; and
enabling the displayed delivery time and date to be selected.

2. A print order receiving method according to claim 1, wherein displaying the difference of said usage fees is performed by indicating said usage fees in relation to the delivery time and date.

3. A print order receiving method according to claim 2, wherein said usage fee is calculated in consideration of a cost to be taken for a printing operation of said print products, which is determined in accordance with said delivery time and date.

4. A print order receiving method according to claim 3, wherein the difference of said usage fees is displayed as a bar graph in which said usage fee is indicated every delivery time and date.

5. A print order receiving apparatus for receiving order information, which is for ordering printing of images, said print order receiving apparatus comprising:
a display for showing difference of usage fees, which are calculated on the basis of a reception status of said order information, relative to delivery time and date of print products; and
an operating portion for selecting said delivery time and date.

6. A print order receiving apparatus according to claim 5, wherein said display shows the difference of said usage fees by indicating said usage fees in relation to the delivery time and date.

7. A print order receiving apparatus according to claim 6, wherein said display shows the difference of said usage fees as a bar graph in which said usage fee is indicated every delivery time and date.

8. A print order receiving apparatus according to claim 7, wherein said operating portion used for selecting the delivery time and date indicated in said bar graph is also used for inputting said order information.

9. A printing system comprising:
a print order receiving apparatus for receiving order information, which is for ordering printing of images;
a printer for printing said image on the basis of said order information; and
a server connected to said print order receiving apparatus and said printer via a communication network to integrally manage operations of said print order receiving apparatus and said printer, said server calculating a usage fee every delivery time and date of print products on the basis of a reception status of said order information,
wherein said print order receiving apparatus includes:
a display for showing difference of the usage fees relative to said delivery time and date; and
an operating portion for selecting the delivery time and date of said print products.

10. A printing system according to claim 9, wherein said display shows the difference of said usage fees by indicating said usage fees in relation to the delivery time and date.

11. A printing system according to claim 10, wherein said server calculates said usage fee in consideration of a cost to be taken for a printing operation of said print products, which is determined in accordance with said delivery time and date.

12. A printing system according to claim 11, wherein said printer and said print order receiving apparatus are placed in a same shop and are mutually connected.

13. A printing system according to claim 11, wherein said printer is placed in a print laboratory specializing in printing the images.

14. A printing system according to claim 10, wherein said display shows the difference of said usage fees as a bar graph in which said usage fee is indicated every delivery time and date.

15. A printing system according to claim 9, wherein said communication network is the Internet.
